(19) United States
(12) Patent Application Publication
(10) Pub. No.: US 2006/0188048 A1
(43) Pub. Date: Aug. 24, 2006

(54) Clock Extracting Circuit

(75) Inventors: Hirohisa Suzuki, Gunma-ken (JP); Kazuo Hasegawa, Gunma-ken (JP); Eiji Akama, Gunma-ken (JP)

Correspondence Address: FISH & RICHARDSON P.C., P.O. BOX 1022, MINNEAPOLIS, MN, 55440-1022, US

(73) Assignee: SANYO ELECTRIC CO., LTD, Osaka (JP)

(21) Appl. No.: 11/275,805

(22) Filed: Jan. 30, 2006

(30) Foreign Application Priority Data
Feb. 2, 2005 (JP) 2005-026715

(51) Int. Cl. H04L 7/02

(52) U.S. Cl. 375/361

(57) ABSTRACT

A clock extracting circuit for receiving an encoded signal and for extracting a clock signal from the encoded signal. The circuit comprises an edge detector that detects rising and falling edges of the encoded signal and produces edge detection pulses indicating the edges being detected; a mask signal generator producing a mask signal which is inverted in response to the edge detection pulses, which are produced one for each period of the received encoded signal, on the basis of the edge detection pulses; a mask signal delay section delaying the mask signal by a delay time controllable and outputting the delayed mask signal; a clock generator producing the clock signal on the basis of edges of the delayed mask signal; and a delay controller that controls the delay time of the mask signal delay section so as to set a duty ratio of the produced clock signal to a predetermined value.

### CROSS-REFERENCE TO RELATED APPLICATIONS

The present application claims priority from Japanese Patent Application No. 2005-26715 filed on Feb. 2, 2005, which is herein incorporated by reference.

### BACKGROUND OF THE INVENTION

1. Field of the Invention

The present invention relates to a clock extracting circuit.

2. Description of the Related Art

Through communication networks such as LANs in offices and vehicle-mounted networks, digital signals are transmitted between apparatuses in the form of signals of various formats. Communication networks are beginning to be used to connect various digital apparatuses other than computers as well as being used to connect computers and their peripherals. An example thereof is vehicle-mounted networks and, for example, a MOST (Media Oriented Systems Transport) system has been proposed as a standard for vehicle-mounted networks. In the MOST system, a ring-like vehicle-mounted network is configured, and various apparatuses such as a car navigation system, a CD/DVD player, a speaker, a display, a telephone are connected to the network. The vehicle-mounted network is used, for example, in a way that the CD/DVD player transmits a reproduced digital signal to the speaker via the vehicle-mounted network and that the speaker converts the digital signal into voice and outputs it.

In transmission of digital signals through a communication network, usually a digital signal and a clock signal are multiplexed (encoded) for high speed/long distance transmission. FIG. 9 shows an example of a digital signal transmission system where a digital signal and a clock signal are multiplexed. On a digital signal transmit side, an encoding circuit 10 multiplexes a clock signal and a digital signal of NRZ (Non-Return to Zero) code format. This multiplexed signal (hereinafter called an encoded signal) is transmitted via a driver 11 and a transmission path to a receiver 12 on a digital signal receive side. On the digital signal receive side, a clock extracting circuit 14 extracts the original clock signal from the received digital signal, and a decoding circuit 13 decodes the received digital signal into the original digital signal based on the clock signal and the like.

FIG. 10 shows an example of the encoded signal. For example, for digital data “1010011” as shown in FIG. 10(a), its NRZ code is represented as a signal shown in FIG. 10(b); bi-phase code (also called Manchester code) is represented as a signal shown in FIG. 10(c); differential bi-phase code is represented as a signal shown in FIG. 10(d), and f/2f code (also called FM code) is represented as a signal shown in FIG. 10(e).

The NRZ code shown in FIG. 10(b) is basic transmission code, where bit values “1” and “0” of digital data are corresponding to an H level and an L level. The bi-phase code shown in FIG. 10(c) is code where bit values “1” and “0” of digital data are corresponding to two codes 180 degrees different in phase. That is, each bit of digital data has a level transition (a rising edge or a falling edge) at its center timing. The level transitions provide clock signal information. In the differential bi-phase code shown in FIG. 10(d), the bit value “1” of digital data is corresponding to a code having a level transition at the center timing of the bit value “1”, while the bit value “0” of digital data is corresponding to a code having its level inverted at the leading boundary timing. The f/2f code shown in FIG. 10(e) is code where bit values “1” and “0” of digital data are corresponding to two signals different in frequency, and is the same as the differential bi-phase code except being shifted in phase by half of a bit period relative to the differential bi-phase code.

FIG. 11 shows the configuration of a conventional clock extracting circuit for the differential bi-phase code, and FIG. 12 is a timing chart showing the operation of the conventional clock extracting circuit of FIG. 11.

First, the differential bi-phase code (see FIG. 12(b)) for digital data of a predetermined bit rate (see FIG. 12(a)) is transmitted to the conventional clock extracting circuit. An exclusive OR gate 16 performs an exclusive OR operation between the differential bi-phase code received and a delayed signal (see FIG. 12(c)) produced by a delay circuit 15 delaying the differential bi-phase code by a predetermined amount of time. The results of this operation are edge detection pulses (see FIG. 12(d)) indicating the rising edges and falling edges of the received differential bi-phase code being detected. An AND gate 17 performs an AND operation between the edge detection pulses and the output of a mono-multivibrator 18 (see FIG. 12(e)). The mono-multivibrator 18 generates a pulse of a predetermined width at the falling edge of a trigger signal (see FIG. 12(f)) that is the output of the AND gate 17.

The conventional clock extracting circuit performs the above series of operations and provides as a clock signal the output of the mono-multivibrator 18 based on the edge detection pulses from the received differential bi-phase code. The conventional clock extracting circuit is disclosed in, for example, Japanese Patent Application Laid-Open Publication No. H11-136295.

However, in the conventional clock extracting circuit as shown in FIG. 11, the delay time of a delay circuit for extracting the clock signal such as the mono-multivibrator is fixed beforehand. For example, mono-multivibrators usually output a pulse from the waveform of charging/discharging a capacitor. Hence, the pulse width of the clock signal is fixed based on the capacitance C of the capacitor predetermined. Also, the delay time of the delay circuit for generating the edge detection pulses is fixed beforehand based on the amount of delay of the delay element thereof. That is, the pulse width of the edge detection pulses is fixed.

As such, with the conventional clock extracting circuit, the pulse widths of the clock signal and of the edge detection pulses are fixed. Thus, where the bit rate of the digital signal is not predetermined or a wide range of bit rates from low speed to high speed need to be dealt with, the duty ratio of the clock signal varies. Furthermore, variation in characteristics of circuit elements in the conventional clock extracting circuit causes the duty ratio of the clock signal to vary.

Note that the clock signal is used in decoding the received encoded signal into its original digital signal. If an edge of the received encoded signal coincides with an edge of the clock signal thus violating the setup/hold time, the original digital signal cannot be appropriately decoded into with the clock signal. Moreover, where as the bit rate becomes higher, the pulse width of the clock signal needs to become narrower, an appropriate clock signal may not be obtained due to deformation of the waveform.

In order to appropriately perform a decoding process and the like using the clock signal at the later stage, the duty ratio of the clock signal is preferably 50%, providing an enough margin. However, because the duty ratio of the clock signal varies depending on the bit rate and the like of the digital signal as mentioned above, an appropriate decoding process or the like may not be performed.

### SUMMARY OF THE INVENTION

According to one aspect of the present invention to solve the above and other problems, there is provided a clock extracting circuit for receiving an encoded signal into which a digital signal subject to transmission has been encoded based on a clock signal and for extracting the clock signal from the encoded signal. The clock extracting circuit comprises an edge detector that detects rising edges and falling edges of the received encoded signal and produces edge detection pulses indicating the respective edges being detected; a mask signal generator that produces a mask signal which is inverted in phase in response to the edge detection pulses, which are produced one for each period of the received encoded signal, on the basis of the edge detection pulses one for the each period; a mask signal delay section that delays the mask signal by a delay time controllable and outputs the delayed mask signal; a clock generator that produces the clock signal on the basis of edges of the delayed mask signal; and a delay controller that controls the delay time of the mask signal delay section so as to set a duty ratio of the produced clock signal to a predetermined value.

According to the invention, there is provided a clock extracting circuit that appropriately extracts a clock signal from an encoded signal received from the outside.

Features and objects of the present invention other than the above will become apparent from the description of this specification and the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram illustrating the configuration of a differential bi-phase decoder having a clock extracting circuit according to an implementation of the present invention;

FIG. 2 is a diagram illustrating the configuration of a bias circuit and a non-inverting delay circuit according to the implementation of the present invention;

FIG. 3 is a diagram illustrating the configuration of a variable current source according to the implementation of the present invention;

FIG. 4 is a diagram illustrating the configuration of an inverting delay circuit according to the implementation of the present invention;

FIG. 5 shows schematically (a) a case where in response to an input rectangular wave, a trapezoidal charge-discharge waveform is obtained and (b) a case where in response to an input rectangular wave, a triangular charge-discharge waveform is obtained;

FIG. 6 is a timing chart showing the operation of the differential bi-phase decoder according to the implementation of the present invention.

FIG. 7 is a diagram illustrating the configuration of a bi-phase decoder having a clock extracting circuit according to an implementation of the present invention;

FIG. 8 is a timing chart showing the operation of the bi-phase decoder according to the implementation of the present invention;

FIG. 9 shows the configuration of a digital signal transmission system;

FIG. 10 shows an example of an encoded signal having a clock signal and a digital signal multiplexed;

FIG. 11 shows the configuration of a conventional clock extracting circuit for differential bi-phase code; and

FIG. 12 is a timing chart showing the operation of the conventional clock extracting circuit for differential bi-phase code.

### DETAILED DESCRIPTION OF THE INVENTION

At least the following matters will be made clear by the explanation in the present specification and the description of the accompanying drawings.

<First Implementation>

==Configuration of Differential Bi-phase Decoder==

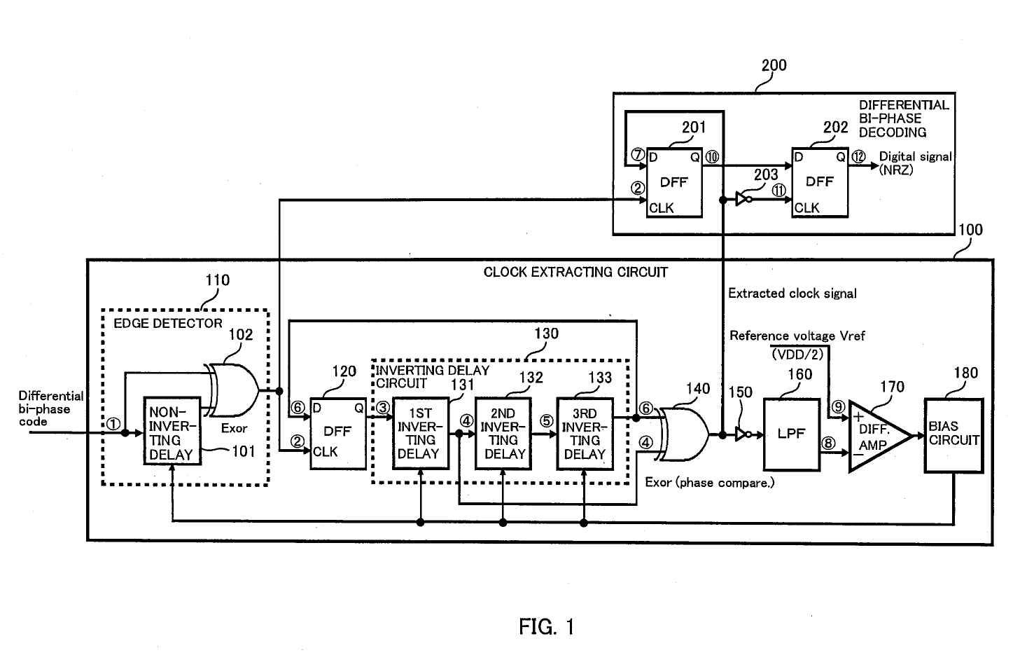

FIG. 1 is a diagram illustrating the configuration of a differential bi-phase decoder having a clock extracting circuit according to an implementation of the present invention. The differential bi-phase decoder of FIG. 1 receives a differential bi-phase code signal (encoded signal) into which a digital signal of a predetermined bit rate that is subject to transmission has been differential-bi-phase-encoded based on a clock signal, and decodes the received differential bi-phase code. Let r be the bit rate (bps) of the digital signal, then the frequency of the clock signal is expressed as “in (a natural number)×r (Hz)”. Hereinafter, “n=1” is assumed.

The differential bi-phase decoder of FIG. 1 comprises a clock extracting circuit 100 that extracts a clock signal from differential bi-phase code received from the outside and a differential bi-phase decoding circuit 200 that decodes the differential bi-phase code received from the outside into its original digital signal (NRZ code). Note that the differential bi-phase decoder of FIG. 1 can also be used as an apparatus for decoding f/2f code.

First, the configuration of the clock extracting circuit 100 will be described. The clock extracting circuit 100 comprises an edge detector 110, a DFF (D flip-flop) 120, an inverting delay circuit 130, an exclusive OR gate 140, an inverter 150, an LPF (Low Pass Filter) 160, a differential amplifier 170, and a bias circuit 180.

The edge detector 110 is an implementation of an edge detector according to the present invention. The edge detector 110 detects the rising edges and falling edges of the differential bi-phase code (marked as circled 1 in FIG. 1) received from the outside and produces edge detection pulses indicating an edge being detected. The edge detector 110 comprises a non-inverting delay circuit 101 and an exclusive OR gate 102.

The non-inverting delay circuit 101 is an implementation of an encoded signal delay section according to the present invention. The non-inverting delay circuit 101 outputs a delayed differential bi-phase code signal (delayed encoded signal) produced by delaying the differential bi-phase code received from the outside by a delay time having the same control response as that of an inverting delay circuit 130 described later. Since the non-inverting delay circuit 101 is non-inverting, the delayed differential bi-phase code signal is the same in logic as the differential bi-phase code. Note that the same control response means that the amount of control (the level of a bias signal) according to a deviation (the output of the differential amplifier 170) is the same.

The delay time of the non-inverting delay circuit 101 together with that of the inverting delay circuit 130 is controlled collectively. Also, the delay time of the non-inverting delay circuit 101 is set shorter than that of the inverting delay circuit 130. Specifically, the delay time of the non-inverting delay circuit 101 is half that of the inverting delay circuit 130.

The exclusive OR gate 102 is an implementation of an edge detection pulse generator according to the present invention. The exclusive OR gate 102 produces edge detection pulses (marked as circled 2 in FIG. 1) showing phase differences between the differential bi-phase code received from the outside and the delayed differential bi-phase code signal. Note that the edge detection pulses intrinsically include pulses produced periodically one for each period corresponding to the bit rate of the differential bi-phase code and a pulse in the middle of a period.

The DFF 120 is an implementation of a mask signal generator according to the present invention. The DFF 120 produces a mask signal (marked as circled 3 in FIG. 1) that is inverted in phase in response to edge detection pulses produced periodically one for each period corresponding to the bit rate of the differential bi-phase code received from the outside, on the basis of the edge detection pulses.

The DFF 120 has inputs thereto as the data a delayed mask signal (marked as circled 6 in FIG. 1) produced by the inverting delay circuit 130 delaying the mask signal and as the clock the edge detection pulses (circled 2 in FIG. 1). That is, the DFF 120 latches the level of the delayed mask signal on the rising edge of the edge detection pulses. This latched logic level is output as the level of the mask signal.

The inverting delay circuit 130 is an implementation of a mask signal delay section according to the present invention. The inverting delay circuit 130 delays the mask signal by a delay time controllable by PLL control described later and outputs the delayed mask signal (circled 6 in FIG. 1).

The exclusive OR gate 140 is an implementation of a clock generator according to the present invention. The exclusive OR gate 140 extracts a clock signal from delayed mask signals on the basis of their edges. The clock signal is inverted by an inverter 150 and supplied to an LPF 160. The clock signal is also supplied to the differential bi-phase decoding circuit 200.

Here, the clock signal is set to have a swing level of from ground potential GND to power supply potential VDD. That is, one level (H level) of the clock signal is at power supply potential VDD and the other level (L level) is at ground potential GND. Thus, the duty ratio of the clock signal is expressed as, e.g., “duration of being at power supply potential VDD/period of the clock signal”.

A circuit that comprises the LPF 160, the differential amplifier 170, and the bias circuit 180 is an implementation of a delay controller according to the present invention. The circuit comprising the LPF 160, the differential amplifier 170, and the bias circuit 180 feed-back controls collectively the delay times of the non-inverting delay circuit 101 and of the inverting delay circuit 130 so as to set the duty ratio of the clock signal to a predetermined value. This feed-back control functions like so-called PLL control. Note that the predetermined value for the duty ratio of the clock signal is preferably 50% for dealing with bit rate variation of the digital signal or appropriately performing a decoding process and the like at the later stage using the clock signal.

The LPF 160 is for smoothing the level of the clock signal inverted.

The differential amplifier 170 is an implementation of a differential amplifier according to the invention. The differential amplifier 170 has a reference voltage vref applied to its non-inverting input terminal and the clock signal via the LPF 160 applied to its inverting input terminal. The reference voltage Vref is half of power supply potential VDD. The differential amplifier 170 amplifies the difference between the level of the clock signal via the LPF 160 (marked as circled 8 in FIG. 1) and the reference voltage Vref (marked as circled 9 in FIG. 1).

The bias circuit 180 is an implementation of a bias circuit according to the invention. The bias circuit 180 can control the swing level for the non-inverting delay circuit 101 and the inverting delay circuit 130 in the same control response, and supplies a bias signal corresponding to the swing level to set the delay times of the non-inverting delay circuit 101 and the inverting delay circuit 130.

Next, the configuration of the differential bi-phase decoding circuit 200 will be described. The differential bi-phase decoding circuit 200 comprises DFFs 201, 202 and an inverter 203.

The DFF 201 has the output of the exclusive OR gate 140, a clock signal (marked as circled 7 in FIG. 1), inputted as the data input and the output of the exclusive OR gate 102, the edge detection pulses (circled 2 in FIG. 1), inputted as the clock input. As a result, the data output of the DFF 201 (marked as circled 10 in FIG. 1) is RZ (Return to Zero) code into which the differential bi-phase code has been decoded.

The DFF 202 has the data output of the DFF 201 (circled 10 in FIG. 1) inputted as the data input and an inverted clock signal output by the inverter 203 (circled 11 in FIG. 1) inputted as the clock input. As a result, the data output of the DFF 202 (marked as circled 12 in FIG. 1) is NRZ (Return to Zero) code into which the differential bi-phase code has been decoded, its original digital signal.

The configuration of the decoder having the clock extracting circuit 100 according to the invention has been described above.

In the implementation, the inverting delay circuit 130 may comprise, instead of a single delay circuit, a first delay circuit that outputs a first delayed mask signal (marked as circled 4 in FIG. 1) produced by delaying the mask signal by a first delay time controllable by PLL control described later and a second delay circuit that outputs a second delayed mask signal (circled 6 in FIG. 1) produced by delaying the first delayed mask signal by a second delay time in the same control response as with the first delay time. Here, the first and second delay times being in the same control response is ensured by the bias circuit 180 supplying the same bias signal to the first and second delay circuits of the inverting delay circuit 130.

In this case, the exclusive OR gate 140 detects phase differences between the first delayed mask signal (circled 4 in FIG. 1) and the second delayed mask signal (circled 6 in FIG. 1) and outputs a clock signal indicating the detected phase differences and having a swing level of from ground potential GND to power supply potential VDD. Here, the duration that the clock signal is at the one level (H level) is equal to the second delay time. In controlling the duty ratio of the clock signal to be 50%, the delay time of the non-inverting delay circuit 101 and the first and second delay times of the inverting delay circuit 130 are controlled collectively based on the phase differences between the first and second delayed mask signals so as to set the second delay time to half of a period corresponding to the bit rate of the differential bi-phase code.

Moreover, in the implementation, the first delay circuit of the inverting delay circuit 130 may be a first inverting delay circuit 131 that inverts and delays the mask signal, the output of the DFF 120, by the first delay time, and the second delay circuit of the inverting delay circuit 130 may comprise a second inverting delay circuit 132 that inverts and delays a first delayed signal, the output of the first inverting delay circuit 131, by the first delay time and a third inverting delay circuit 133 that inverts and delays the output of the second inverting delay circuit 132 by the first delay time to produce a second delayed signal.

In this case, the second delay time of the second delay circuit of the inverting delay circuit 130 is the sum of the first delay times of the second inverting delay circuit 132 and the third inverting delay circuit 133. Furthermore, in controlling the duty ratio of the clock signal to be 50%, the delay time of the non-inverting delay circuit 101 and the first delay times of the first to third inverting delay circuit (131, 132, 133) are controlled collectively based on the phase differences between the first and second delayed mask signals (circled 4 and circled 6 in FIG. 1) so as to set the second delay time to half of a period corresponding to the bit rate of the differential bi-phase code.

==Configuration of Bias Circuit and Non-inverting Delay Circuit==

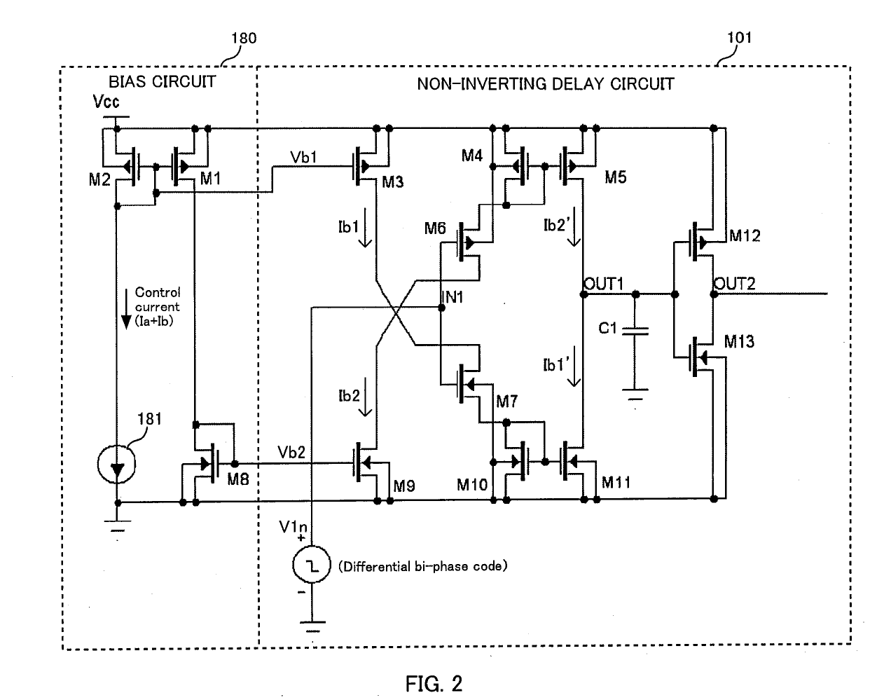

FIG. 2 is a diagram illustrating the configuration of the bias circuit 180 and the non-inverting delay circuit 101 according to the implementation of the present invention.

The bias circuit 180 is embodied as a current mirror circuit that generates a bias signal (bias voltage or current) for the non-inverting delay circuit 101 according to the output current (hereinafter called a control current) of a variable current source 181. This bias signal is supplied to the non-inverting delay circuit 101 and eventually sets charge and discharge currents for a capacitor C1 of the non-inverting delay circuit 101 (currents Ib1′, Ib2′ in FIG. 2).

In the current mirror circuit for the bias circuit 180, two P-MOSFET transistors M1, M2 are provided in between power supply line Vcc and ground line GND, whose gate electrodes are connected to each other, and the gate and drain electrodes of the transistor M2 are short-circuited to form a diode. The variable current source 181 is provided between the drain electrode of the transistor M2 and the ground line, and an N-MOSFET transistor M8 is provided between the drain electrode of the transistor M1 and the ground line. The gate and drain electrodes of the transistor M8 are short-circuited to form a diode.

In this configuration of the current mirror circuit, a current path for the control current of the variable current source 181 is formed through the transistor M2 between the power supply line and the ground line. Also, a current path for a current copied from the control current of the variable current source 181 is formed through the transistors M1, M8 between the power supply line and the ground line.

For the connection of the bias circuit 180 and the non-inverting delay circuit 101, for example, the gate electrode of a P-MOSFET transistor M3 is connected to the gate electrodes of the transistors M1, M2 of the bias circuit 180. As a result, the transistors M1, M2, M3 form a current mirror circuit. Meanwhile, the gate electrode of an N-MOSFET transistor M9 is connected to the gate electrode of the transistor M8 of the bias circuit 180. As a result, the transistors M8, M9 form a current mirror circuit.

In the non-inverting delay circuit 101, a P-MOSFET transistor M6 and an N-MOSFET transistor M7 are provided in between power supply line Vcc and ground line GND, whose gate electrodes are connected to each other, and the differential bi-phase code received from the outside is supplied through an input terminal IN1 to the gate electrodes of the transistors M6, M7. The transistors M6, M7 operate complimentarily according to the level of the differential bi-phase code received from the outside.

A current mirror circuit consisting of two P-MOSFET transistors M4, M5 is provided between the power supply line and the source electrode of the transistor M6. A transistor M9 is provided between the drain electrode of the transistor M6 and the ground line. Meanwhile, a transistor M3 is provided between the power supply line and the drain electrode of the transistor M7. A current mirror circuit consisting of two N-MOSFET transistors M10, M11 is provided between the source electrode of the transistor M7 and the ground line.

The drain electrodes of the transistors M5, M11 are connected to each other, and a capacitor C1 is provided between an output terminal OUT1 on the connection line of the two transistors and the ground line. The capacitance of the capacitor C1 is half that of the capacitors C2, C3, C4 of the first, second, and third inverting delay circuits 131, 132, 133. That is, the delay time of the non-inverting delay circuit 101 is set to be half that of the first, second, and third inverting delay circuits 131, 132, 133.

The output terminal OUT1 is connected to the input terminal of an inverter having the P-MOSFET transistor M12 and the N-MOSFET transistor M13 connected in series between the power supply line and the ground line.

With the configuration of the non-inverting delay circuit 101, when the differential bi-phase code is at the L level, the transistor M6 is rendered conductive and the transistor M7 is rendered non-conductive. Thus, a current path for current Ib2 is formed through the transistors M4, M6, M9. The current Ib2 is copied into the transistor M5 via the current mirror circuit consisting of the transistors M4, M5. Let current Ib2′ be this copied current. The current Ib2′ is a charging current for the capacitor C1. The charge waveform across the capacitor C1 becomes the H level. Hence, the transistor M13 is rendered conductive and the transistor M12 non-conductive. Through the output terminal OUT2 of the inverter, the L level is output which coincides with the level of the differential bi-phase code.

On the other hand, when the differential bi-phase code is at the H level, the transistor M7 is rendered conductive and the transistor M6 non-conductive. Thus, a current path for current Ib1 is formed through the transistors M3, M7, M10. The current Ib1 is copied into the transistor M11 via the current mirror circuit consisting of the transistors M10, M11. Let current Ib2′ be this copied current. The current Ib1′ is a discharging current for the capacitor C1. The discharge waveform across the capacitor C1 becomes the L level. Hence, the transistor M12 is rendered conductive and the transistor M13 non-conductive. Through the output terminal OUT2 of the inverter, the H level is output which coincides with the level of the differential bi-phase code.

As such, the non-inverting delay circuit 101 delays the differential bi-phase code supplied to the input terminal IN1 by the time of charging/discharging the capacitor C1 that depends on the bias signal from the bias circuit 180. The non-inverting delay circuit 101 outputs the delayed, non-inverted, differential bi-phase code through the output terminal OUT2.

==Configuration of Variable Current Source==

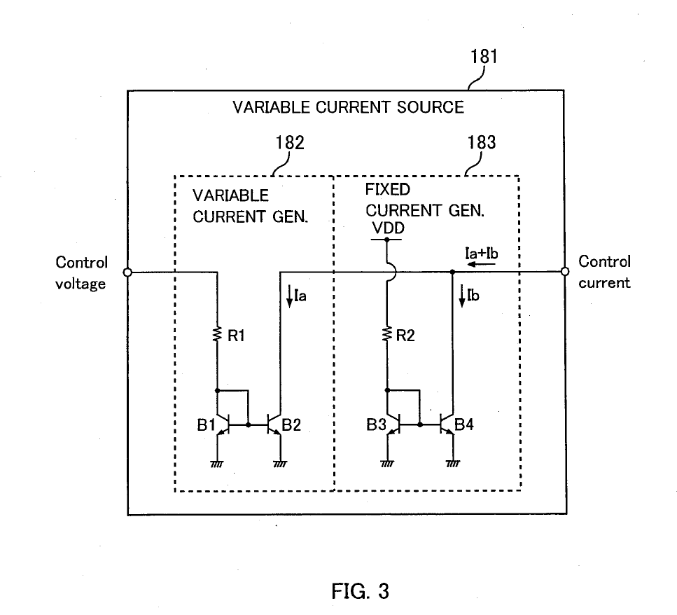

FIG. 3 is a diagram illustrating the configuration of the variable current source 181 according to the implementation of the present invention.

The variable current source 181 comprises a variable current generator 182 and a fixed current generator 183.

The variable current generator 182 has the control voltage from the differential amplifier 170 applied to a first resistor R1 thereby producing a variable current Ia. The variable current generator 182 is constituted by a current mirror circuit consisting of two NPN bipolar transistors B1, B2 where their base electrodes are connected to each other and the transistor B1 is connected to form a diode. The control voltage from the differential amplifier 170 is applied to the collector electrode of the transistor B1 through the first resistor R1.

The fixed current generator 183 has the power supply potential VDD applied to a second resistor R2 thereby producing a fixed current Ib. The fixed current generator 183 is constituted by a current mirror circuit consisting of two NPN bipolar transistors B3, B4 where their base electrodes are connected to each other and the transistor B3 is connected to form a diode. The power supply potential VDD is applied to the collector electrode of the transistor B3 through the second resistor R2.

Furthermore, the collector electrodes of the transistor B2 of the variable current generator 182 and of the transistor B4 of the fixed current generator 183 are connected, and a current through the connection point becomes the control current. That is, the variable current source 181 outputs the combined current (Ia+Ib) of the variable current Ia produced by the variable current generator 182 and the fixed current Ib by the fixed current generator 183 as the control current.

==Configuration of Inverting Delay Circuit==

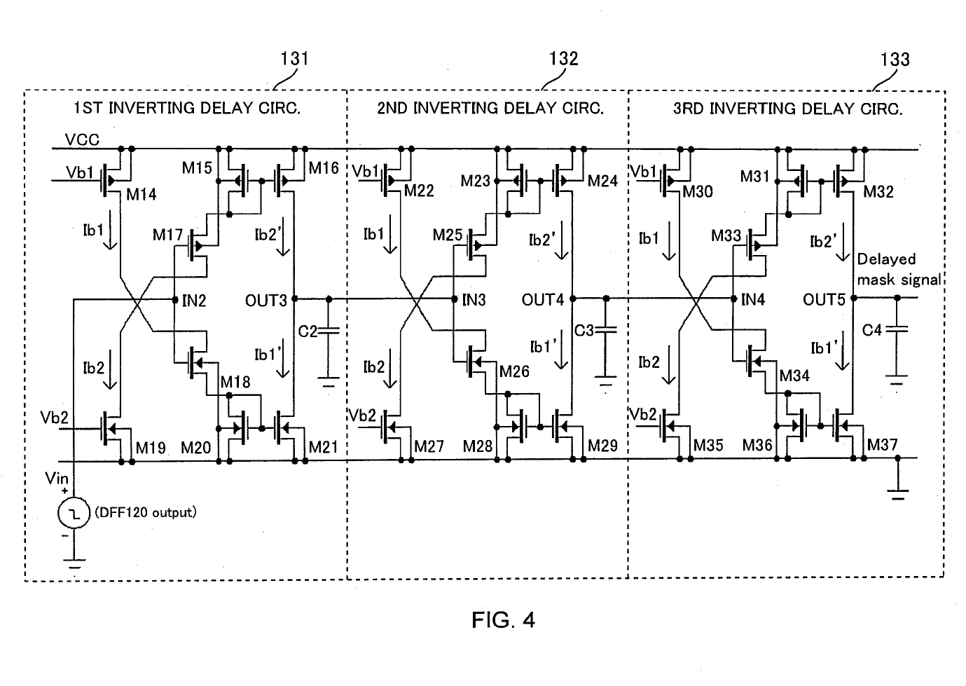

FIG. 4 is a diagram illustrating the configuration of the inverting delay circuit 130 according to the implementation of the present invention.

The inverting delay circuit 130 of FIG. 4 has the first, second, and third inverting delay circuits 131, 132, 133 connected in series. The first, second, and third inverting delay circuits 131, 132, 133 are the same in configuration as the non-inverting delay circuit 101 of FIG. 2 except without having an inverter (the transistors M12, M13) of the last stage like the non-inverting delay circuit 101.

The capacitances of the capacitors C2, C3, C4 of the first, second, and third inverting delay circuits 131, 132, 133 are the same value and twice that of the capacitor Cl of the non-inverting delay circuit 101. That is, the delay times of the first, second, and third inverting delay circuits 131, 132, 133 show the same control response and are twice that of the non-inverting delay circuit 101.

To simplify the circuit configuration of the clock extracting circuit 100, the output of the bias circuit 180 connected to the non-inverting delay circuit 101 is also connected to the first, second, and third inverting delay circuits 131, 132, 133. That is, the bias circuit 180 is shared among the non-inverting delay circuit 101 and the first, second, and third inverting delay circuits 131, 132, 133. However, the bias circuits 180 may be provided one each for the non-inverting delay circuit 101 and the first, second, and third inverting delay.

As such, the inverting delay circuit 130 having the first, second, and third inverting delay circuits 131, 132, 133 connected in series delays the mask signal supplied to its input terminal IN2 by the sum of the times of charging/discharging the capacitors C2, C3, C4 that depends on the bias signal from the bias circuit 180. The inverting delay circuit 130 outputs the delayed mask signal obtained by delaying and inverting the mask signal through its output terminal OUT5.

==Charge/Discharge Waveform in Non-inverting and Inverting Delay Circuits==

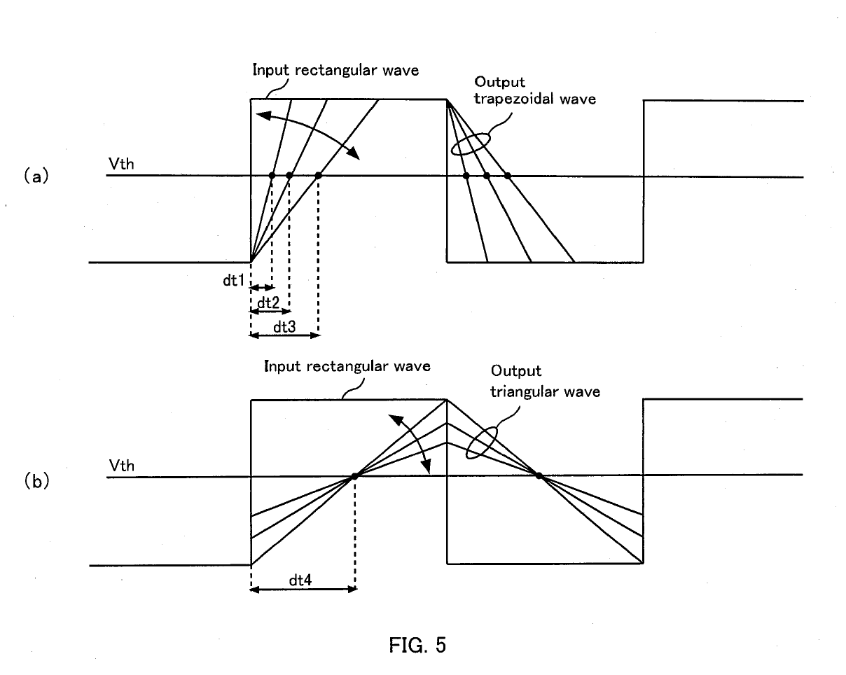

FIG. 5(a) shows schematically a case where in response to an input rectangular wave (the differential bi-phase code or mask signal) inputted to the non-inverting delay circuit 101 or the inverting delay circuit 130, a trapezoidal charge-discharge waveform (hereinafter called an output trapezoidal wave) is obtained. In this case, the slope of the output trapezoidal wave is decided by the capacitances of the capacitors C1, C2, C3, C4 and the level of the bias signal from the bias circuit 180, i.e., the control current (Ia+Ib) from the variable current source 181. As shown in FIG. 5(a), if the slope of the output trapezoidal wave varies, time from the rising edge of the input rectangular wave until the level of the output trapezoidal wave reaches a predetermined threshold voltage Vth, i.e., charge time (delay time) varies.

FIG. 5(b) shows schematically a case where in response to an input rectangular wave (the differential bi-phase code or mask signal) inputted to the non-inverting delay circuit 101 or the inverting delay circuit 130, a triangular charge-discharge waveform (hereinafter called an output triangular wave) is obtained. In this case, the slope of the output triangular wave is also decided by the capacitances of the capacitors C1, C2, C3, C4 and the control current (Ia+Ib) from the variable current source 181. However, as shown in FIG. 5(b), if the slope of the output triangular wave varies, time from the rising edge of the input rectangular wave until the level of the output triangular wave reaches the predetermined threshold voltage Vth, i.e., charge time (delay time) does not vary but is constant. In the case of the output triangular wave, a dead band occurs where the charge time does not respond to variation in the level of the control current (Ia+Ib) from the variable current source 181.

Hence, not the triangular charge-discharge waveform but the trapezoidal charge-discharge waveform needs to be formed as the charge-discharge waveform across the capacitors C1, C2, C3, C4. To form the trapezoidal charge-discharge waveform, the resistance ratio of the first resistor R1 of the variable current generator 182 to the second resistor R2 of the fixed current generator 183, and the capacitances of the capacitor C1 of the non-inverting delay circuit 101 and the capacitors C2, C3, C4 of the inverting delay circuit 130 are set accordingly.

==Operation of Differential Bi-phase Decoder==

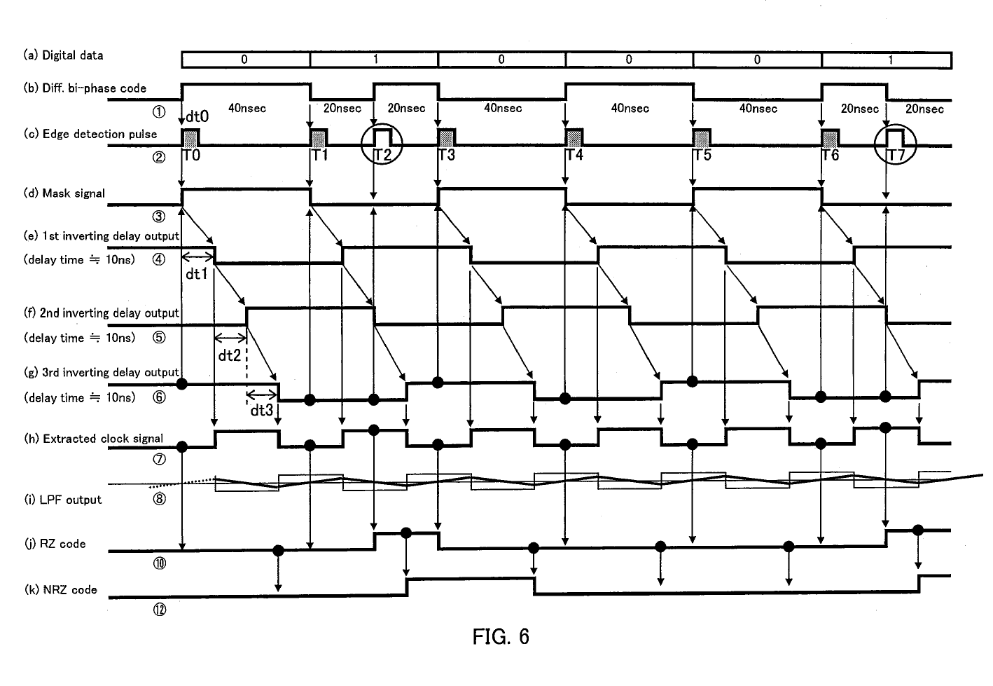

FIG. 6 is a timing chart showing the operation of the differential bi-phase decoder according to the implementation of the present invention.

In FIG. 6, waveforms denoted by reference numerals circled 1 to circled 8, circled 10, circled 12 represent waveforms at nodes denoted by the same reference numerals in FIG. 1.

An external transmit side apparatus (not shown) encodes digital data of “1010001” having a bit period of 40 ns (see FIG. 6(a)) into a differential bi-phase code (see FIG. 6(b)), which is input to the edge detector 110. Here, it is assumed that the output of the third inverting delay circuit 133 (see FIG. 6(g)) is initialized beforehand to be at the H level and the output of the exclusive OR gate 140 (see FIG. 6(h)) to be at the L level.

At time T0, the edge detector 110 produces an edge detection pulse of duration corresponding to the delay time dt0 of the non-inverting delay circuit 101. The DFF 120 latches the H level output of the third inverting delay circuit 133 on the rising edge of the edge detection pulse. As a result, the mask signal, the output of the DFF 120, rises from the L level to the H level (see FIG. 6(d)) and is input to the first inverting delay circuit 131 of the inverting delay circuit 130.

The first inverting delay circuit 131 inverts and delays the mask signal input from the DFF 120 by a delay time dt1 (first delay time) (see FIG. 6(e)). The first delayed mask signal output from the first inverting delay circuit 131 is input to the second inverting delay circuit 132 and to an input of the exclusive OR gate 140.

The second inverting delay circuit 132 inverts and delays the first delayed mask signal from the first inverting delay circuit 131 by a delay time dt2 (first delay time) (see FIG. 6(f)). The output of the second inverting delay circuit 132 is input to the third inverting delay circuit 133.

The third inverting delay circuit 133 inverts and delays the output of the second inverting delay circuit 132 by a delay time dt3 (first delay time) (see FIG. 6(g)). The second delayed mask signal output from the third inverting delay circuit 133 is input to the other input of the exclusive OR gate 140.

The exclusive OR gate 140 performs an exclusive OR operation between the first delayed mask signal output from the first inverting delay circuit 131 and the second delayed mask signal output from the third inverting delay circuit 133. The first and second delayed mask signals are different in logic level for the sum (a second delay time) of the delay time dt2 and the delay time dt3 of the second inverting delay circuit 132 and the third inverting delay circuit 133.

Hence, in the period of time from the falling edge of the first delayed mask signal to the rising edge of the second delayed mask signal, i.e., the phase difference between the two signals, the output of the exclusive OR gate 140 is at the H level (see FIG. 6(h)) and is the clock signal supplied to the differential bi-phase decoding circuit 200.

The clock signal that is the output of the exclusive OR gate 140 is input via the inverter 150 to the LPF 160 and smoothed (see FIG. 6(i)). The smoothed clock signal has a swing level of from ground potential GND to power supply potential VDD. The differential amplifier 170 amplifies the difference between the level of the clock signal smoothed by the LPF 160 and the reference voltage Vref that is half of the power supply potential VDD. The amplified difference indicates to what degree the current duty ratio of the clock signal is away from an ideal value of 50%.

The bias circuit 180 is supplied with the control voltage output from the differential amplifier 170. This control voltage is converted by the variable current source 181 into the control current. The bias signal (bias voltage or current) whose level is controlled according to the control current is supplied to the non-inverting delay circuit 101 and the first, second, and third inverting delay circuits 131, 132, 133 collectively. As a result, the delay time dt0 of the non-inverting delay circuit 101 and the delay times dt1, dt2, dt3 of the first, second, and third inverting delay circuits 131, 132, 133 are controlled collectively so as to set the duty ratio of the clock signal to 50%.

Here, the flow of delay control according to the present invention will be described for a case where an H level period of the clock signal is long. In such a case, the delay times dt0 to dt3 need to be shortened for the next period (time T1 to time T3) of the clock signal. To this end, the H level of the clock signal is inverted and input to the LPF 160. Since the L level period of the inverted clock signal input to the LPF 160 is long, the output level of the LPF 160 descends below the reference voltage Vref. Hence, the differential amplifier 170 performing an operation “the reference voltage Vref−the output level of the LPF 160” outputs a positive level. The positive level output from the differential amplifier 170 sets the delay times dt0 to dt3 to be short for the next period.

For a case where conversely an H level period of the clock signal is short, the flow of delay control according to the invention will be described. In such a case, the delay times dt0 to dt3 need to be elongated for the next period (time T1 to time T3) of the clock signal. To this end, the H level of the clock signal is inverted and input to the LPF 160. Since the L level period of the inverted clock signal input to the LPF 160 is short, the output level of the LPF 160 does not descend enough to be below the reference voltage Vref but remains above it. Hence, the differential amplifier 170 performing the operation “the reference voltage Vref−the output level of the LPF 160” outputs a negative level. The negative level output from the differential amplifier 170 sets the delay times dt0 to dt3 to be long for the next period.

In the differential bi-phase decoding circuit 200, the DFF 201 latches the L level of the clock signal after initialized, on the rising edge of the edge detection pulse. Hence, an RZ code output from the DFF 201 takes on the L level corresponding to “0” of the digital signal.

Moreover, the output of the DFF 201 is inputted as data to the DFF 202 and the H level, the inverse of the L level of the clock signal after initialized, is inputted as the clock. Since the clock input is at the H level, the DFF 202 outputs the L level without latching. That is, an NRZ code output from the DFF 202 takes on the L level corresponding to “0” of the digital signal.

Subsequently, the above series of operations are performed at times T1, T3, T4, T5, T7. Note that at times T2, T7 circled in FIG. 6(c), which are located at the center of bit periods of the digital data, the mask signal is not inverted. That is, each of time periods between bit boundaries of the digital data is one period of the differential bi-phase code.

For example, at time T2, the second delayed mask signal inputted as data to the DFF 120 remains at the same L level as at time T1. Hence, the DFF 120 latches the L level on the rising edge of the edge detection pulse like at time T1, and thus its output is not inverted. As such, if an edge detection pulse occurs in one period of the differential bi-phase code, the mask signal is not inverted, and thus no change occurs in the control of the delay times dt0 to dt3. That is, if an edge detection pulse occurs in one period of the differential bi-phase code, the edge detection pulse is masked (invalidated).

<Second Implementation>

==Configuration of Bi-phase Decoder==

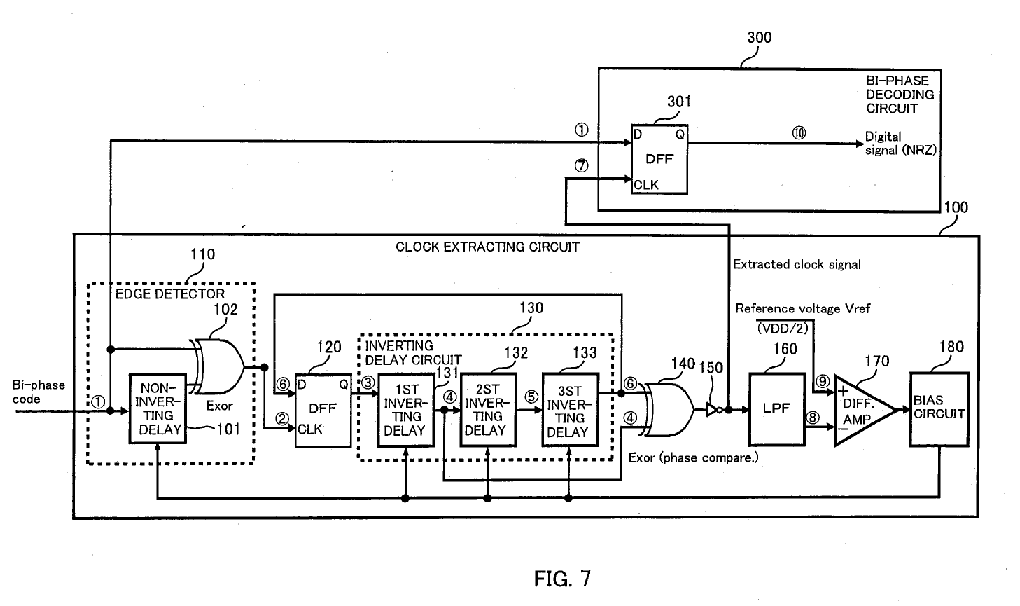

FIG. 7 is a diagram illustrating the configuration of a bi-phase decoder having a clock extracting circuit according to an implementation of the present invention. The bi-phase decoder of FIG. 7 receives a bi-phase code signal (encoded signal) into which a digital signal of a predetermined bit rate that is subject to transmission has been bi-phase-encoded based on a clock signal, and decodes the received bi-phase code.

The clock extracting circuit of the bi-phase decoder of FIG. 7 is the same in configuration as the clock extracting circuit 100 of the differential bi-phase decoder except that the clock signal is the output of the inverter 150. In the clock extracting circuit of FIG. 7, the same reference numerals denote the same or like parts as in the clock extracting circuit of FIG. 1. In the bi-phase decoder of FIG. 7, a bi-phase decoding circuit 300 is different in configuration from the differential bi-phase decoding circuit 200.

The bi-phase decoding circuit 300 is constituted by a DFF 301. The DFF 301 has a bi-phase code (marked as circled 1 in FIG. 7) received from the outside inputted as the data input and the clock signal (marked as circled 7 in FIG. 7) output from the inverter 150 inputted as the clock input. As a result, the data output of the DFF 301 (marked as circled 10 in FIG. 7) is NRZ code into which the bi-phase code has been decoded, i.e., its original digital signal.

==Operation of Bi-Phase Decoder==

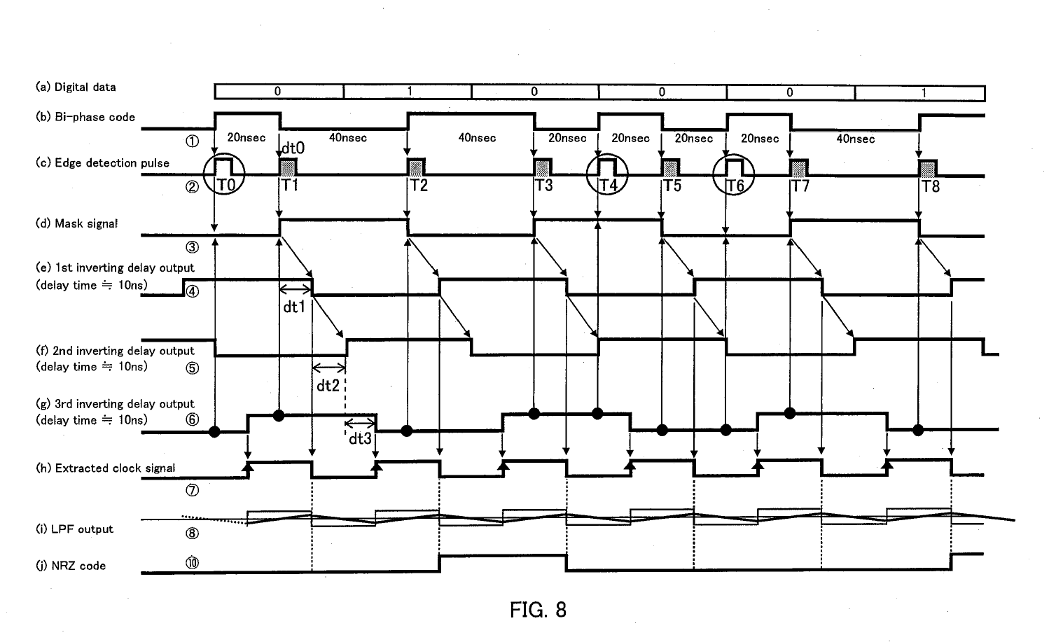

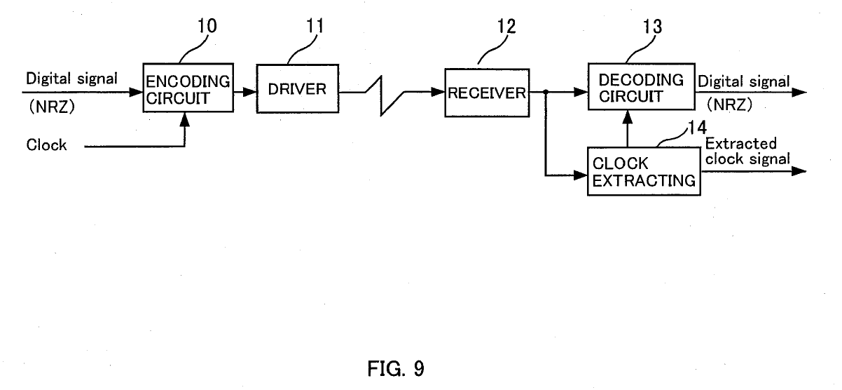

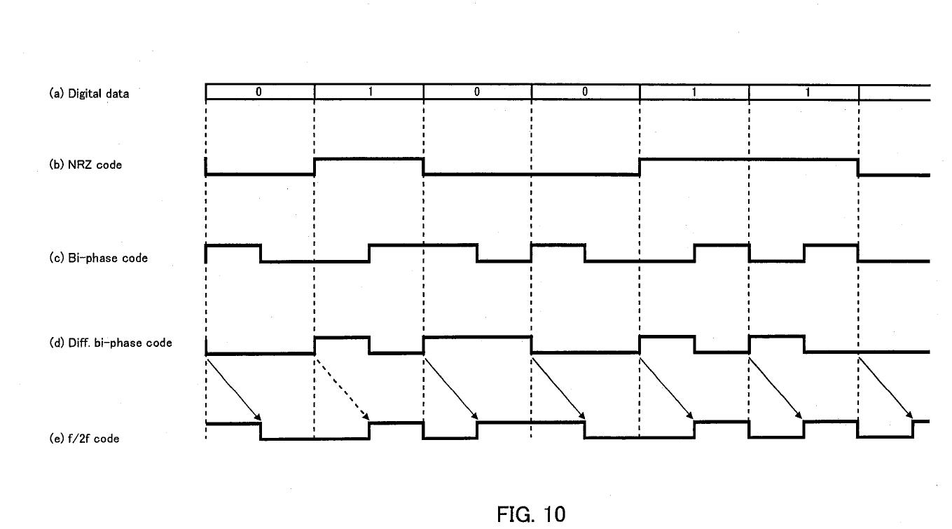

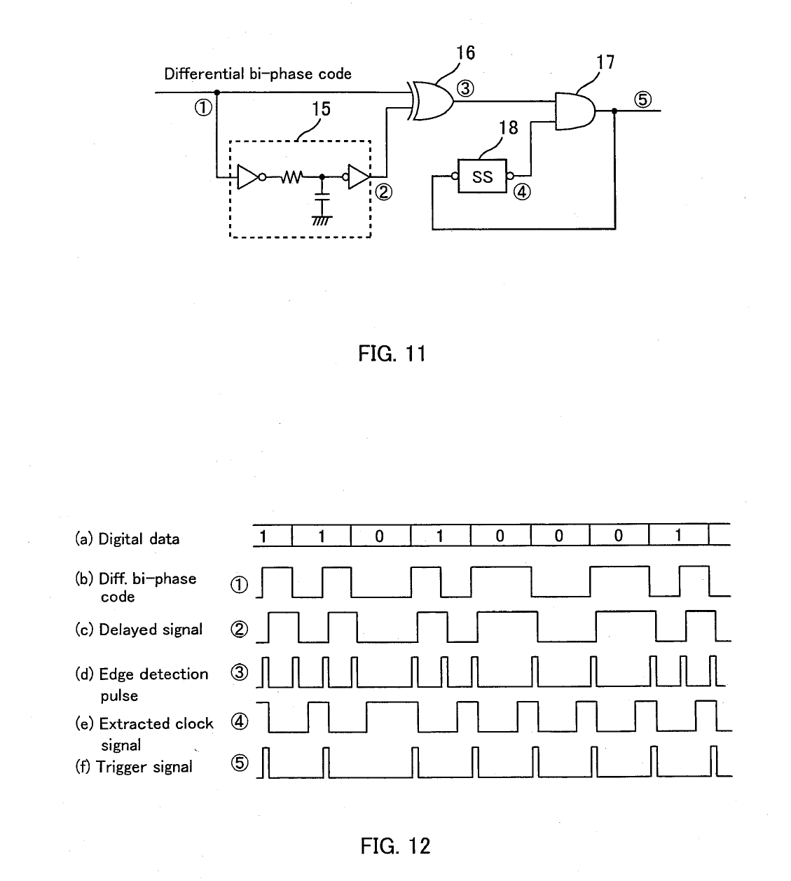

FIG. 8 is a timing chart showing the operation of the bi-phase decoder according to the implementation of the present invention.

In FIG. 8, waveforms denoted by reference numerals circled 1 to circled_8, circled_10 represent waveforms at nodes denoted by the same reference numerals in FIG. 7. Like with the differential bi-phase decoder of FIG. 6, a bi-phase code (see FIG. 8(b)) into which digital data of “010001” having a bit period of 40 ns (see FIG. 8(a)) has been encoded is input to the edge detector 110. Here, it is assumed that the output of the third inverting delay circuit 133 (see FIG. 8(g)) is initialized beforehand to be at the L level and the output of the inverter 150 (see FIG. 8(h)) to be at the L level.

The difference from the differential bi-phase decoder is that at times T0, T4, T6 circled in FIG. 8(c), which are located at bit boundaries of the digital data, the mask signal is not inverted. That is, each of time periods between the centers of the bit periods of the digital data is one period of the bi-phase code.

For example, at time T4, the second delayed mask signal inputted as data to the DFF 120 remains at the same H level as at time T3. Hence, the DFF 120 latches the H level on the rising edge of the edge detection pulse like at time T3, and thus its output is not inverted. As a result, no change occurs in the control of the delay times dt0 to dt3 with the edge detection pulse being masked.

The bi-phase decoding circuit 300 operates as follows. For example, from time T2 to time T3 the bi-phase code continues to be at the H level. The event that the H or L level continues for a bit period indicates that the digital data has changed from “1” to “0” or from “0” to “1”. Accordingly, the DFF 301 latches the H level of the bi-phase code from time T2 to time T3 on the rising edge of the edge detection pulse. As a result, the DFF 301 outputs the H level corresponding to “1” of the digital data at time T2.

<Examples of Effect>

In the clock extracting circuit 100 according to the present invention, the edge detector 110 produces the edge detection pulses indicating that rising edges and falling edges of a received encoded signal (one of the differential bi-phase code, the bi-phase code and the f/2f code) have been detected. On the basis of edge detection pulses produced periodically one for each period of the received encoded signal, the mask signal is produced which is inverted upon the occurrence of each periodic edge detection pulse.

The mask signal is not inverted upon the occurrence of an edge detection pulse in each period. The edge detection pulse in each period is masked. The masking of such edge detection pulses is a necessary process in extracting clocks from the encoded signal having two types of pulse widths, wide and narrow ones, such as the bi-phase code, the differential bi-phase code, or the f/2f code. On the basis of edges of the delayed mask signal produced by the inverting delay circuit 130 delaying the mask signal, the clock signal is extracted, while the delay times of the inverting delay circuit 130 are controlled so as to set the duty ratio of the clock signal to 50%.

Thus, even if the bit rate of the digital data varies, the masking of edge detection pulses is performed without error, the delay times for extracting clocks follow the bit rate of the digital data. Further, the duty ratio of the clock signal extracted from the encoded signal of the digital data settles at 50%, providing an enough margin. Therefore, according to the present invention, even in circumstances where the bit rate of a digital signal changes between high bit rates and low bit rates for dealing with degradation of quality of the transmission path, the clock extraction and the later decoding process are appropriately performed.

The inverting delay circuit 130 preferably comprises the first delay circuit that outputs a first delayed mask signal produced by delaying the mask signal by the first delay time and the second delay circuit that outputs the second delayed mask signal produced by delaying the first delayed mask signal by the second delay time. In this case, the exclusive OR gate 140 extracts the clock signal on the basis of the phase differences between the first delayed mask signal and the second delayed mask signal. Also, the first and second delay times in the same control response are controlled collectively via the LPF 160, the differential amplifier 170, the bias circuit 180 and the like based on the phase differences between the first and second delayed mask signals so as to set the second delay time at half the bit period of the digital signal.

As a result, the clock signal is easily extracted on the basis of the phase differences between the first and second delayed mask signals. Time periods in which the clock signal has the one level are decided by the second delay time of the second delay circuit. Hence, in order to control the duty ratio of the clock signal to be at 50%, the second delay time of the second delay circuit need only be controlled to be at half the period of the encoded signal, which can be implemented by a simple mechanism. The control of the second delay time of the second delay circuit is performed in the same control response as the control of the first delay time of the first delay circuit. Hence, variation in the phase differences between the first and second delayed signals is suppressed, and thus the control to set the duty ratio of the clock signal to be at 50% can be performed highly accurately.

Moreover, the inverting delay circuit 130 preferably has the first to third inverting delay circuits (131, 132, 133) connected in series which each delay by the first delay time in the same control response. In this case, the same delay control need only be performed on the first to third inverting delay circuits (131, 132, 133), and thus the control to set the duty ratio of the clock signal to be at 50% can be performed highly accurately with a simple mechanism.

In the above implementations, the differential amplifier 170 amplifies the difference between the detected level of the clock signal having the predetermined swing level (e.g., power supply potential VDD to ground potential GND) and the reference level Vref (e.g., VDD/2) that is half of the predetermined swing level. The bias signal supplied to the first and second delay circuits for setting the first and second delay times is controlled in level according to the output of the differential amplifier 170.

As a result of this control, the level of the clock signal approaches the reference level Vref. When the level of the clock signal coincides with the reference level Vref, the duty ratio of the clock signal settles at about 50%. During this, the level of the bias signal for setting the first and second delay times collectively is controlled, and thereby the control to set the duty ratio of the clock signal to be at 50% can be performed highly accurately with a simple mechanism.

In the above implementations, the bias circuit 180 is embodied as a current mirror circuit that generates the bias signal according to the control current (Ia+Ib) of the variable current source 181, and consists of the variable current generator 182 and the fixed current generator 183. Thus, the first and second delay times are controlled by controlling mainly the level of the variable current Ia that is generated by the variable current generator 182.

When the level of the clock signal coincides with the reference level Vref, the control voltage output from the differential amplifier 170 becomes a predetermined offset level close to the zero level. In this case, the variable current generator 182 does not operate and the variable current Ia becomes zero. Because the fixed current generator 183 is provided separately from the variable current generator 182, of the control current (Ia+Ib) of the variable current source 181, the fixed current Ib of the fixed current generator 183 flows constantly regardless of the control voltage from the differential amplifier 170. Hence, the bias circuit 180 operates stably. Thus, the control to set the duty ratio of the clock signal to be at 50% is stabilized.

In the above implementations, the variable current generator 182 and the fixed current generator 183 are each embodied as a current mirror circuit consisting of two bipolar transistors. Bipolar transistors develop a stable voltage drop of Vbe when conductive. Hence, the variable current Ia and the fixed current Ib are stabilized in level compared with the case where the variable current generator 182 and the fixed current generator 183 are embodied as a current mirror circuit consisting of two MOS transistors. Thus, the first and second delay times are controlled highly accurately and the control to set the duty ratio of the clock signal to be at 50% is stabilized.

In the above implementations, the first and second delay circuits are embodied as charge/discharge circuits where the charging and discharging of the capacitors C1 to C4 are switched according to the mask signal and the first delayed mask signal and where the trapezoidal charge-discharge waveform is produced across the capacitors C1 to C4 based on the level of the bias signal from the bias circuit 180.

Here, where a triangular charge-discharge waveform is produced across the capacitors C1 to C4 in response to input rectangular wave signals such as the mask signal and the first delayed mask signal, a dead band occurs where the first and second delay times cannot be controlled. Accordingly, the clock extracting circuit is configured to have the trapezoidal charge-discharge waveform produced across the capacitors C1 to C4 in response to input rectangular wave signals such as the mask signal and the first delayed mask signal. As a result, the occurrence of the dead band is prevented, and the control to set the duty ratio of the clock signal to be at 50% can be performed stably.

Furthermore, in the above implementations, if the bit rate of the digital signal changes, the pulse width of the edge detection pulses needs to be changed accordingly together with the duty ratio of the clock signal. For example, as the bit rate of the digital signal becomes higher, one period of the encoded signal received becomes shorter. Hence, to perform appropriate edge detection pulse masking, the width of the edge detection pulses needs to be narrower.

The edge detector 110 has the non-inverting delay circuit 101 delaying the received encoded signal. Accordingly, the clock extracting circuit 100 controls the delay times of the inverting delay circuit 130 and the non-inverting delay circuit 101 in the same control response. As a result, even if the bit rate of the digital signal changes, the appropriate edge detection pulses corresponding to the bit rate are produced, thus stabilizing the control to set the duty ratio of the clock signal to be at 50%.

Moreover, in the above implementations, the DFF 120 has the second delayed mask signal inputted as data and the edge detection pulses as clocks, and outputs the mask signal. Also, the delay time of the non-inverting delay circuit 101 is set shorter than (e.g., half) that of the inverting delay circuit 130. As a result, the DFF 120 stably latches the level of the second delayed mask signal on the edge of the edge detection pulse and produces the appropriate mask signal, thus stabilizing the control to set the duty ratio of the clock signal to be at 50%.

Although the implementations of the present invention have been described, the above implementations are provided to facilitate the understanding of the present invention and not intended to limit the present invention. It should be understood that various changes and alterations can be made therein without departing from spirit and scope of the invention and that the present invention includes its equivalents.

What is claimed is:

1. A clock extracting circuit for receiving an encoded signal into which a digital signal subject to transmission has been encoded based on a clock signal and for extracting the clock signal from the encoded signal, the clock extracting circuit comprising:
an edge detector that detects rising edges and falling edges of the received encoded signal and produces edge detection pulses indicating the respective edges being detected;
a mask signal generator that produces a mask signal which is inverted in phase in response to the edge detection pulses, which are produced one for each period of the received encoded signal, on the basis of the edge detection pulses one for the each period;
a mask signal delay section that delays the mask signal by a delay time controllable and outputs the delayed mask signal;
a clock generator that produces the clock signal on the basis of edges of the delayed mask signal; and
a delay controller that controls the delay time of the mask signal delay section so as to set a duty ratio of the produced clock signal to a predetermined value.

2. The clock extracting circuit according to claim 1, wherein the predetermined value is 50%.

3. The clock extracting circuit according to claim 2, wherein the mask signal delay section comprises:
a first delay circuit that outputs a first delayed mask signal produced by delaying the mask signal by a first delay time controllable; and
a second delay circuit that outputs a second delayed mask signal produced by delaying the first delayed mask signal by a second delay time having the same control response as the first delay time,
wherein the clock generator produces the clock signal on the basis of phase differences between the first and second delayed mask signals, and
wherein the delay controller controls collectively the first and second delay times based on the phase differences so as to set the second delay time to half of the period.

4. The clock extracting circuit according to claim 3, wherein the first delay circuit is a first inverting delay circuit that inverts and delays the mask signal by the first delay time, and the second delay circuit comprises:
a second inverting delay circuit that inverts and delays the first delayed mask signal by the first delay time, and
a third inverting delay circuit that outputs the second delayed mask signal produced by inverting and delaying the output of the second inverting delay circuit by the first delay time,
wherein the second delay time is a sum of the first delay times of the second and third inverting delay circuits, and
wherein the delay controller controls collectively the first delay times of the first to third inverting delay circuits based on the phase differences so as to set the second delay time to half of the period.

5. The clock extracting circuit according to claim 3, wherein the clock generator detects phase differences between the first and second delayed mask signals and produces the clock signal having a predetermined swing level and showing the phase differences, and
wherein the delay controller comprises:
a differential amplifier that amplifies a difference between a level of the clock signal and a reference level that is half of the predetermined swing level, and
a bias circuit that supplies a bias signal to set the first and second delay times of the first and second delay circuits to be corresponding to a controllable level of the bias signal, and the delay controller controls the level of the bias signal being supplied to the first and second delay circuits on the basis of an output of the differential amplifier.

6. The clock extracting circuit according to claim 5, wherein the bias circuit is constituted by a current mirror circuit that generates the bias signal according to an output current of a variable current source, and the variable current source comprises:
a variable current generator that has the voltage output of the differential amplifier applied to a first resistor thereby producing a variable current, and
a fixed current generator that has power supply potential applied to a second resistor thereby producing a fixed current, and a combined current of the variable current and the fixed current is the output current.

7. The clock extracting circuit according to claim 6, wherein the variable current generator and the fixed current generator are each constituted by a current mirror circuit having two bipolar transistors where their base electrodes are connected to each other and one of the bipolar transistors is connected to form a diode.

8. The clock extracting circuit according to claim 5, wherein the first and second delay circuits are each constituted by a capacitor and a charge-discharge circuit that switches charging/discharging the capacitor in response to level switching of the mask signal or the first delayed mask signal to have a trapezoidal charge-discharge waveform corresponding to the level of the bias signal produced across the capacitor and to form the first or second delayed mask signal from the charge-discharge waveform.

9. The clock extracting circuit according to claim 1, wherein the edge detector comprises:
an encoded signal delay section that outputs a delayed encoded signal produced by delaying the received encoded signal by a delay time having the same control response as the delay time of the mask signal delay section, and
an edge detection pulse generator that produces the edge detection pulses that correspond to phase differences between the received encoded signal and the delayed encoded signal, and
wherein the delay controller controls collectively the delay times of the mask signal delay section and the encoded signal delay section.

10. The clock extracting circuit according to claim 9, wherein the mask signal generator is constituted by a D flip-flop circuit having the delayed mask signal inputted as its data and the edge detection pulses inputted as its clock and provides a data output of the D flip-flop circuit as the mask signal, and
wherein the delay time of the encoded signal delay section is set shorter than the delay time of the mask signal delay section.

11. The clock extracting circuit according to claim 9, wherein the clock generator detects phase differences between the first and second delayed mask signals and produces the clock signal having a predetermined swing level and showing the phase differences, and
wherein the delay controller comprises:
a differential amplifier that amplifies a difference between a level of the clock signal and a reference level that is half of the predetermined swing level, and
a bias circuit that supplies a bias signal to set the delay times of the encoded signal delay section and of the mask signal delay section to be corresponding to a controllable level of the bias signal, and the delay controller controls the level of the bias signal being supplied to the encoded signal delay section and the mask signal delay section on the basis of an output of the differential amplifier.

12. The clock extracting circuit according to claim 11, wherein the encoded signal delay section and the mask signal delay section are each constituted by a capacitor and a charge-discharge circuit that switches charging/discharging the capacitor in response to level switching of the encoded signal or the mask signal to have a trapezoidal charge-discharge waveform corresponding to the level of the bias signal from the bias circuit produced across the capacitor and to form the delayed encoded signal or the delayed mask signal from the charge-discharge waveform.

13. The clock extracting circuit according to claim 1, wherein the encoded signal is any one of a bi-phase code signal, a differential bi-phase code signal, and an f/2f code signal.
